(19) United States
(12) Patent Application Publication
(10) Pub. No.: US 2004/0073373 A1
(43) Pub. Date: Apr. 15, 2004

(54) Inertial augmentation of seismic streamer positioning

(76) Inventor: Colin A. Wilson, Oslo (NO)

Correspondence Address: Jeffrey A. Pyle, Williams, Morgan & Amerson, P.C., Suite 250, 7676 Hillmont, Houston, TX, 77040, US

(21) Appl. No.: 10/269,685

(22) Filed: Oct. 10, 2002

(51) Int. Cl. G01V 1/00

(52) U.S. Cl. 702/16

(57) ABSTRACT

The present invention provides an improved method and apparatus for positioning seismic arrays. The method comprises determining a first position of an array, deploying the array, collecting inertial data at a plurality of points on the array once the array is at least partially deployed, and determining a second position of the array by augmenting the first position with the inertial data. The apparatus comprises a seismic array, an inertial sensor mounted on the seismic array and capable of gathering inertial data, and a computing device adapted to receive and analyze the inertial data to determine a position for the seismic array from the inertial data.

### BACKGROUND OF THE INVENTION

1. Field of the Invention

This invention relates generally to seismic surveying, and, more particularly, to positioning seismic streamer arrays.

2. Description of the Related Art

Subsurface hydrocarbon accumulations are increasingly found in geologically complex areas. The ability to conduct accurate seismic surveys may help improve the discovery rates and even the production of such accumulations. Seismic surveying is a method of simulating a geological subsurface formation with, e.g., electrical, magnetic, and/or acoustic signals to acquire seismic data about the formation. From this data, one can hopefully tell whether the formation contains hydrocarbon deposits and, if so, where.

In marine seismic surveying, an acoustic array containing acoustic sensors and sources typically is deployed. In one variation, an array of marine seismic streamers is towed behind a seismic survey vessel. Each streamer typically is several thousand meters long and contains a large number of hydrophones and associated electronic equipment distributed along its length. The seismic survey vessel also tows one or more seismic sources, typically air guns. In another variation, the acoustic arrays are deployed on the seafloor. The seismic sources may be positioned at some distance away from the seismic survey vessel as a separate mobile or semi-mobile unit.

In either case, acoustic signals, or “shots,” produced by seismic sources are directed down through the water into the earth beneath, where they are reflected from the various strata. The reflected signals are received by the hydrophones in the array, digitized, and transmitted to the seismic survey vessel, where they are recorded. The recorded signals are at least partially processed with the ultimate aim of building up a representation of the earth strata in the area being surveyed. The representation may be read or interpreted to discover and locate hydrocarbon deposits.

To enable the subsurface structures to be correctly reconstructed from the reflected acoustic data, accurate positions for the source and receiver arrays are important. Positions for the source and receiver arrays may be determined using combinations of direct and indirect positioning systems and devices. An example of a direct positioning system is a system based on the Global Positioning System (“GPS”), in which one or more GPS receivers are placed on the arrays.

Direct positioning systems are typically supplemented with indirect positioning systems, such as a seismic reflection system. A seismic reflection system typically incorporates optical or acoustic reflectors and receivers, magnetic heading sensors, and other acoustic devices. For example, multiple acoustic devices may be mounted on the towed array as well as on surface referenced objects, such as independently towed surface buoys and tailbuoys. Acoustic ranges can be measured to the acoustic devices on the towed arrays. The accuracy of indirect positioning systems may suffer from bubbles and turbulence caused by towing the array through the water.

With respect to seafloor-deployed arrays, indirect measurements to a surface referenced position are typically used because of the difficulty of receiving satellite navigation data through air-sea transmissions. Indirect measurements, however, do not provide the most accurate measurement for seafloor-deployed arrays because the arrays can drift underwater as they are being deployed. Other uncertainties can be introduced by, e.g., imprecision in knowledge of physical, environmental conditions, such as acoustic velocity in the water column, water depth, current velocity, etc.

The accuracy and reliability of the positioning network rely heavily on the optimal placement of all relative positioning devices. As used throughout, the term “positioning network” refers to a system of various sources, sensors, and other devices in accordance with conventional practice that are placed on a seismic cable for determining locations. Of particular importance is the reliability of the positioning network acoustic ranges between the towed arrays and the surface referenced objects. The accuracy and reliability of the positioning network, and therefore the determined positions, can suffer significantly if the positioning network geometry becomes unstable. Instability may be caused by a loss or lack of ranges in the network or a lack of redundancy in the determined positions. The present invention is directed to overcoming, or at least reducing the effects of, one or more of the problems set forth above.

### SUMMARY OF THE INVENTION

The invention provides an improved method for positioning seismic arrays. The method comprises determining a first position of an array, deploying the array, collecting inertial data at a plurality of points on the array once the array is at least partially deployed, and determining a second position of the array by augmenting the first position with the inertial data.

The invention provides an improved apparatus for positioning seismic arrays. The apparatus comprises a seismic array, an inertial sensor mounted on the seismic array and capable of gathering inertial data, and a computing device adapted to receive and analyze the inertial data to determine a position for the seismic array from the inertial data.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a towed acoustic array and a towed source array, in accordance with one embodiment of the present invention;

FIG. 2 illustrates one of the acoustic receivers of FIG. 1, in accordance with one embodiment of the present invention;

FIG. 3 illustrates a flow diagram of a method of deploying a seismic array, in accordance with one embodiment of the present invention; and

FIG. 4 illustrates a flow diagram of a method of determining the position of an array, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

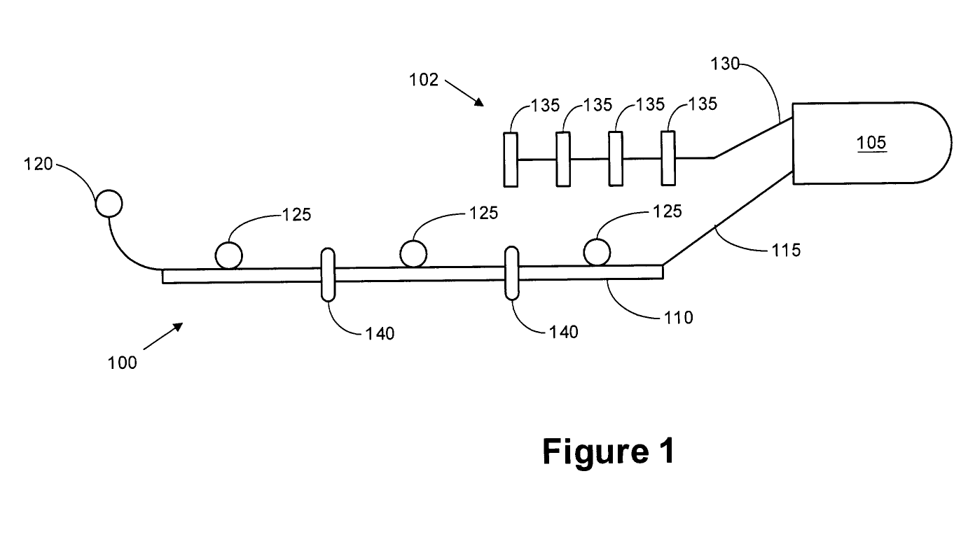

FIG. 1 illustrates an acoustic array 100 and a towed source array 102, in accordance with one embodiment of the present invention. A seismic survey vessel 105 tows a seismic streamer 110 by way of a first tow cable 115. The streamer 110 may comprise a tailbuoy 120. The tailbuoy 120 typically identifies the end of the streamer 110. The streamer 110 is additionally provided with one or more leveling devices or “birds” 125 that regulate the depth of the streamer 110 within the water. The seismic survey vessel 105, by way of a second tow cable 130, also tows one or more acoustic sources 135, such as compressed air guns. The acoustic sources 135 generate acoustic waves in the water that generally travel in a downward direction toward the seafloor (not shown) in accordance with conventional practice. The acoustic waves reflect from various structures within the seafloor (not shown), and the reflected waves are detected by one or more acoustic receivers 140, such as hydrophones, in the streamer 110.

As discussed in greater detail below, one or more of the tailbuoy 120, the acoustic sources 135, the acoustic receivers 140, and/or other devices used in seismic exploration (hereinafter collectively referred as “seismic devices”) may be equipped with positioning devices (not shown), such as a Global Positioning System (“GPS”) receiver or an inertial sensor, for monitoring the location of the seismic devices. As is well known in the art, upon receipt of the reflected waves, the acoustic receiver 140 typically generates analog signals. The analog signals may be converted to digital signals by analog-to-digital converters (not shown) in the streamer 110 and transmitted along the streamer 110 and the tow cable 115, 130 to the seismic survey vessel 105. Although not so limited, the analog-to-digital converter, in one embodiment, may comprise one or more processors adapted to convert analog signals to digital signals. The seismic survey vessel 105 may comprise digital signal devices (not shown) for recording and processing the digital signals.

For the sake of simplicity, FIG. 1 illustrates two towed arrays 100, 102 comprising two tow cables 115, 130 and one streamer 110 attached to the first tow cable 115. However, any number of arrays may contain any number of streamers, in accordance with conventional practice. The two towed arrays 100, 102 may further comprise devices not shown in FIG. 1, in accordance with conventional practice, such as a towed buoy. Furthermore, it should be appreciated that the acoustic sources 135 and the acoustic receivers 140 may be towed by the same cable in alternative embodiments. In still other embodiments, the acoustic sources 135 may be placed on a mobile or semi-mobile unit (not shown) positioned some distance away from the seismic survey vessel 105. In an alternate embodiment, an ocean-bottom cable (“OBC”) (not shown) may be used instead of the seismic streamer 110. OBCs may be deployed on the seafloor to record and relay data to the seismic survey vessel 105. OBCs generally enable surveying in areas where towed streamers 110 are unusable or disadvantageous, such as in areas of obstructions and shallow water inaccessible to ships.

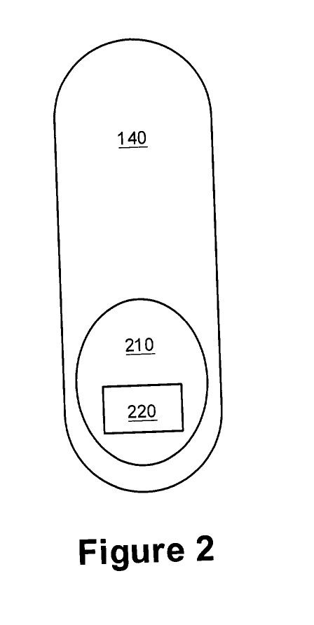

FIG. 2 illustrates one embodiment of the acoustic receiver 140 of FIG. 1, in accordance with one embodiment of the present invention. The acoustic receiver 140 comprises an electronics module 210. The electronics module 210 comprises one or more components for detecting, receiving, and/or processing acoustic signals received from the acoustic source 135 of FIG. 1, as are commonly employed in the art. The electronics module 210 may contain, for example, an analog-to-digital converter. As mentioned, the analog-to-digital converter may comprise one or more processors adapted to convert analog signals to digital signals.

In one embodiment, the electronics module 210 includes an inertial sensor 220 for measuring inertial motion of the acoustic receiver 140 in three axes (i.e., three dimensions): horizontal, vertical, and orthogonal. The data for the axes may be measured in any coordinate system. The inertial sensor 220 comprises one or more components (not shown) that detect and convert mechanical motion of the acoustic receiver 140 to an electrical signal. In one embodiment, the inertial sensor 220 may be an accelerometer. As is well known in the art, a conventional accelerometer generally comprises a proof mass coupled to an instrument case through a restraint, such as a spring or a crystal. The instrument case may be a transducer that returns a signal proportional to the displacement of the proof mass. The instrument case is typically hermetically sealed and may be built to withstand extreme temperatures and pressures.

Accelerometers may measure motion in one axis, two axes, or three axes, in accordance with conventional practice. More than one accelerometer may be combined to measure multiple axes and/or to increase the accuracy of inertial data collected by the accelerometers. Thus, in the illustrated embodiment, the inertial sensor 220 may include one or more accelerometers, depending on the implementation. Although not so limited, it is preferred that a highest quantity of inertial sensors 220 allowable be included in the electronics module 210 to provide greater accuracy and precision. Other embodiments of accelerometers include, but are not limited to, capacitive accelerometers, piezoresistive accelerometers, and piezoelectric accelerometers.

In one embodiment, the inertial sensor 220 may be a model ADXL202/ADLXL210 accelerometer (hereinafter referred as “AD accelerometer”) made by Analog Devices, Inc. The AD accelerometer is a two-axis acceleration sensor on a single integrated circuit (“IC”) chip. Although the AD accelerometer detects and measures motion in only two axes, more than one AD accelerometer may be mounted on the electronics module 210 for measuring the third axis. Furthermore, it should be appreciated that more than one AD accelerometer may be mounted on the electronics module 210 to provide redundancy of the inertial data collected. For example, if one AD accelerometer should fail for any reason, other AD accelerometers mounted on the electronics module 210 may record data that would otherwise be lost.

The electrical signal from the accelerometer may be transmitted along the streamer 110 and the tow cable 115, 130 to the seismic survey vessel 105 of FIG. 1. In other embodiments, the electrical signal from the accelerometer may be transmitted wirelessly to the seismic survey vessel 105, for example, via radio communication. The seismic survey vessel 105 may include a computerized analyzer (not shown) for interpreting the electrical signal and determining the location of the acoustic receiver 140. In one embodiment, the inertial data from the accelerometer may be used independently to determine the location of the acoustic receiver 140. For example, an ocean-bottom cable (“OBC”) may comprise an inertial sensor 220 for detecting inertial motion from a known, fixed position as the OBC is deployed in the water. In other embodiments, the inertial data from the accelerometer may be used to augment positioning data from various other positioning devices, such as Global Positioning System (“GPS”) satellite navigation receivers. The inertial data may be passed continuously to the seismic survey vessel 105 or recorded on a memory module (not shown) mounted on the acoustic receiver 140. It is also appreciated that the motion information may be used as part of a real-time or a post-processed positioning network.

Although FIG. 2 illustrates the acoustic receiver 140 comprising the inertial sensor 220, it should be appreciated that other seismic devices may comprise the inertial sensor 220, such as acoustic sources 135 and tailbuoys 120. Furthermore, it should be appreciated that the inertial sensor 220 may comprise any device or system, in accordance with conventional practice, that is used for detecting and measuring inertial motion, such as a gyro sensor. Any suitable inertial sensor 220 known to the art may be employed.

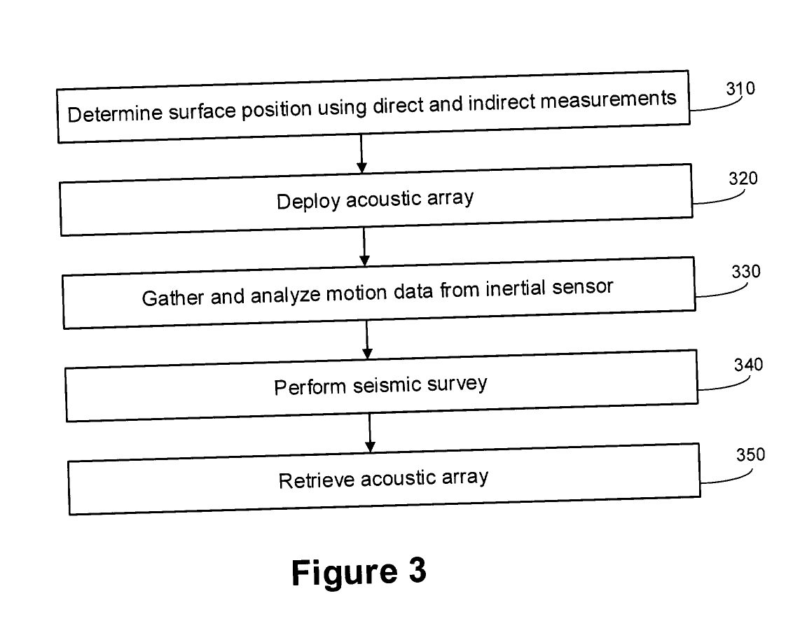

FIG. 3 illustrates a flowchart representation of a method of deploying a cable, in accordance with one embodiment of the present invention. A user on the seismic survey vessel 105 of FIG. 1 determines (at 310) a surface position of a seismic device using any of a variety of direct and indirect surface measurements. This may be performed in accordance with conventional practice.

As previously mentioned, the seismic device may include, but is not limited to, at least one seismic device, i.e., at least one of the acoustic receiver 140, the acoustic source 135, and the tailbuoy 120, shown in FIG. 1. An example of a direct surface measurement includes using a GPS satellite receiver attached to the seismic device. Indirect surface measurements may include determining seismic device positions using a surface referenced device, such as the tailbuoy 120 or the towed source array 102. By attaching indirect measurement devices, such as optical or acoustic reflectors and receivers and magnetic heading sensors to the surface referenced device, acoustic ranges can be measured to the indirect measurement devices to determine the position of the acoustic array 100. The indirect surface measurements may also be used in conjunction with the direct surface measurements to form a positioning network or system.

The user deploys (at 320) the acoustic array 100. In one embodiment, the acoustic array 100 may be deployed on the seafloor. The acoustic array 100 deployed (at 320) on the seafloor is typically an ocean-bottom cable (“OBC”). The OBC generally includes an assembly of geophones and hydrophones 140 connected by electrical wires. The OBC may also include communication lines for transmitting data from the acoustic receivers 140 to the seismic survey vessel 105. In one embodiment, the OBC may comprise four receiver groups, wherein each receiver group comprises three geophones 140 and a hydrophone 140. Each receiver group is typically placed at intervals along the OBC and housed in a protective module designed to protect the acoustic receivers 140. In an alternate embodiment, the seismic streamer 110 of FIG. 1 may be deployed instead of the OBC.

The seismic streamer 110 may comprise a plurality of hydrophones 140 placed about every 10 meters along the array 100. The seismic streamer 110 may further comprise a plurality of electronics modules 210 placed about every 100 or 150 meters along the array 1100. Furthermore, like the OBC, the seismic streamer 110 may also include communication lines for retrieving data from the acoustic receivers 140. The accuracy of the data collected by the acoustic receiver 140 is dependent, at least in part, on the location of the acoustic receiver 140 with respect to the acoustic source 135.

To gather information on the location of the acoustic receiver 140, and thus, the towed acoustic array 100, the acoustic receivers 140 are equipped with inertial sensors 220 as shown in FIG. 2. In some embodiments, all the acoustic receivers 140 are so equipped while in other embodiments only some of the acoustic receivers 140 include inertial sensors 220. The inertial sensor 220 may be placed on a variety of locations along the array 100, depending on the particular implementation. In one embodiment, the inertial sensor 220 may be placed in the electronics module 210, as illustrated in FIG. 2. In an alternate embodiment, the inertial sensor 220 may be placed in a separate module and attached to the array with additional electrical wires and communication lines for transmitting data to the seismic survey vessel 105. Placing the inertial sensor 220 in the electronics module 210 provides several advantages. Because the electronics module 210 is robust and built to withstand a variety of stresses, such as temperature and pressure, the inertial sensor 220 is well protected.

The user gathers and analyzes (at 330) inertial data collected by the inertial sensor 220. For example, the inertial data may be transmitted from the inertial sensor 220 to the seismic survey vessel 105 via radio communication. In one embodiment, the inertial data may be used to determine the final drop location of the OBC (i.e., the location of the OBC on the seafloor). In another embodiment, the inertial data may be used to augment and enhance other direct and indirect positioning data. Having accurate positioning data of the seismic streamer 110 may provide a more accurate analysis of acoustic waves reflected from the earth strata.

The user performs (at 340) seismic surveying on the seafloor, in accordance with conventional practice. A variety of methods of seismic surveying on the seafloor are well known in the art. For example, in one embodiment, a process called “seismic profiling” is used, but alternative embodiments may use alternative methods, such as what is known as “3D Seismic.” Any suitable seismic survey method may be used. Note that the seismic survey (at 340) may be performed before, after, or during the position determination (at 330), depending on the particular embodiment.

In “seismic profiling,” the acoustic source 135 may comprise air guns. The air guns release a “pop” of compressed air to generate low frequency waves. Low frequency waves generally penetrate farther beneath the seafloor. When a sound pulse echoes from the seafloor, typically some fraction of its energy is transmitted into the sediments beneath the sea bottom. These waves reflect off horizons between sedimentary layers, where the physical properties change slightly, and the returning signals tell the thickness and geometry of the sediments. The returning sound waves may be received by the acoustic receiver 140. A recorder may plot successive pings to produce an acoustic picture of the sea bottom, which shows the thickness and geometry of the sediments. This process is generally known as “seismic profiling.” Alternatively, in a process generally known as “3-D seismics,” data is collected in a dense grid such that computers can treat the reflections as a volume, rather than a profile, so that the resulting acoustic picture is in three dimensions.

The user retrieves (at 350) the acoustic array 100 from the seafloor. In one embodiment, the user mechanically pulls the acoustic array 100 from the seafloor to the seismic survey vessel 105. In other embodiments, the seismic survey vessel 105 may comprise an automated system for pulling the acoustic array 100 from the seafloor. Again, any technique known to the art for retrieving the acoustic array 100 may be employed. As those in the art having the benefit of this disclosure will appreciate, retrieval in any given embodiment will depend, at least to some degree, on the implementation of the acoustic array 100.

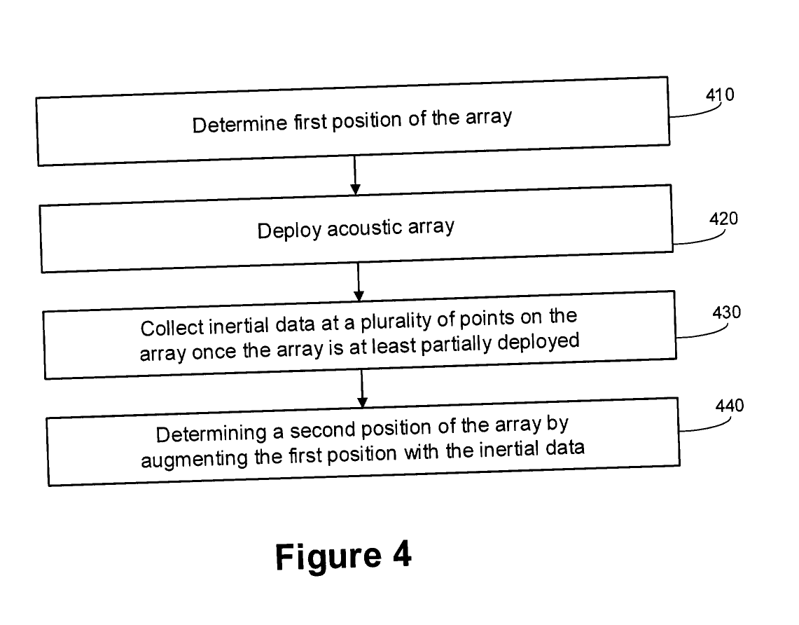

FIG. 4 illustrates a flowchart representation of a method of determining the position of an array 100, in accordance with one embodiment of the present invention. A user on the seismic survey vessel 105 determines (at 410) a first position of the acoustic array 100. The first position may be determined by indirect and/or direct measurement. Any method known in conventional practice may be utilized, such as a Global Positioning System (“GPS”). The first position is generally a surface measurement of the acoustic array 100 prior to deployment. It should be appreciated, however, that the first position may further include measurements after deployment of the acoustic array 100.

The user deploys (at 420) the acoustic array 100. A more detailed discussion is provided in the description of FIG. 3. Any method of deploying the acoustic array 100 known in conventional practice may be used. During deployment of the acoustic array 100, the inertial sensor 220 of FIG. 2, such as the AD accelerometer, collects (at 430) inertial data at a plurality of points on the array 100. As mentioned, the inertial sensor 220 may collect (at 430) inertial data in three axes. The inertial data is used to determine (at 440) a second position of the acoustic array 100 by augmenting the first position with the inertial data. The second position of the acoustic array 100 is generally more accurate than the first position, thus providing a more accurate seismic survey.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for positioning seismic arrays, comprising:
deploying an array;
determining a first position of the array;
collecting inertial data at a plurality of points on the array once the array is at least partially deployed; and
determining a second position of the array by augmenting the first position with the inertial data.

2. The method of claim 1, wherein determining the first position of the array comprises using at least one of a direct and an indirect measurement.

3. The method of claim 2, wherein using at least one of the direct and the indirect measurement comprises using a Global Positioning System measurement.

4. The method of claim 1, wherein collecting inertial data at the plurality of points on the array comprises collecting at least one of horizontal inertial data, vertical inertial data, and orthogonal inertial data.

5. The method of claim 1, wherein further comprising:
collecting seismic data at a plurality of acoustic receivers on the array; and
retrieving the array.

6. The method of claim 5, further comprising performing analysis on the seismic data.

7. The method claim 1, wherein deploying the array comprises deploying an ocean-bottom cable on a seafloor.

8. The method of claim 1, wherein deploying the array comprises towing an acoustic array.

9. An apparatus, comprising:
a seismic array;
an inertial sensor mounted on the seismic array and capable of gathering inertial data; and
a computing device adapted to receive and analyze the inertial data to determine a position for the seismic array from the inertial data and a first position.

10. The apparatus of claim 9, further comprising a seismic survey vessel and a tow cable, wherein the seismic survey vessel tows the seismic array from the tow cable.

11. The apparatus of claim 9, wherein the seismic array comprises an acoustic array.

12. The apparatus of claim 11, wherein the acoustic array comprises at least one acoustic receiver.

13. The apparatus of claim 12, wherein the one or more acoustic receivers may comprise one or more hydrophones.

14. The apparatus of claim 13, further comprising an analog-to-digital converter adapted to convert analog signals received from the one or more hydrophones to digital signals.

15. The apparatus of claim 9, wherein the seismic array comprises a source array.

16. The apparatus of claim 15, wherein the source array comprises at least one acoustic source.

17. The apparatus of claim 16, wherein the at least one acoustic sources comprise at least one airgun.

18. The apparatus of claim 9, wherein the computing device adapted to receive and analyze the inertial data comprises part of a real time positioning network or a post-processed positioning network.

19. The apparatus of claim 9, further comprising an acoustic source positioned in a mobile or a semi-mobile unit.

20. The apparatus of claim 9, wherein the inertial sensor comprises at least one accelerometer.

21. The apparatus of claim 20, wherein the at least one accelerometer measures motion on three axes.

22. An apparatus, comprising:
means for acquiring seismic data;
means for acquiring inertial data mounted on the seismic data acquisition means; and
means for analyzing inertial data acquired by the inertial data acquisition means to determine a position for the seismic data acquisition means from the inertial data and a first position.

23. The apparatus of claim 22, wherein the seismic data acquisition means comprises an acoustic array.

24. The apparatus of claim 22, wherein the analyzing means comprises part of a real time positioning network or a post-processed positioning network.

25. The apparatus of claim 22, wherein the inertial data acquisition means comprises at least one accelerometer.

26. The apparatus of claim 25, wherein the at least one accelerometer measures motion on three axes.
